(19) United States
(12) Patent Application Publication
(10) Pub. No.: US 2006/0146193 A1
(43) Pub. Date: Jul. 6, 2006

(54) Method and system for variable color saturation

(76) Inventors: Chaminda Weerasinghe, Bella Vista (AU); Magnus Nilsson, Gothenburg (SE); Yu Shi, Oatley (AU)

Correspondence Address: MOTOROLA INC, 600 NORTH US HIGHWAY 45, ROOM AS437, LIBERTYVILLE, IL, 60048-5343, US

(21) Appl. No.: 11/027,339

(22) Filed: Dec. 30, 2004

(51) Int. Cl. H04N 9/74; H04N 11/06; H04N 7/01; H04N 11/20

(52) U.S. Cl. 348/582; 348/450; 348/488

(57) ABSTRACT

A low complexity apparatus (100) and method (200) for variable color saturation, performed in combination with RGB to YUV color space conversion, is used to direct input signal noise away from a luminance channel, to which the human eye is highly sensitive, and into chrominance channels. The apparatus (100) is adapted to perform color conversion and variable color saturation of input primary color signals red, green and blue to produce variable chrominance signals and luminance invariance. The apparatus includes a luminance composition module (105) dependent on non-varying luminance composition coefficients. A first chrominance composition module (110) is dependent on the non-varying luminance composition coefficients and includes a first variable saturation coefficient that is multiplied by the difference between low pass filtered red and green primary color signals. A second chrominance composition module (115) is also dependent on the non-varying luminance composition coefficients and includes a second variable saturation coefficient that is multiplied by the difference between low pass filtered blue and green primary color signals.

### FIELD OF THE INVENTION

The present invention relates generally to improving the quality of digital images, and in particular to producing saturated colors for the transmission, compression or display of images.

### BACKGROUND OF THE INVENTION

Color image sensors are often produced using color filter arrays (CFAs) consisting of layers of spectral frequency absorptive material. Ideally, the CFAs are supposed to transmit only red (R), green (G) and blue (B) color components to an underlying photosensitive element. However, due to physical imperfections in CFA material and electron diffusion in silicon substrates, the transmitted color components often differ from ideal color matching functions for R, G and B, resulting in diffusion of a primary color towards another primary color. That produces colors of lower saturation than what is seen by the human eyes. Therefore, it is necessary to perform a color correction or saturation procedure to reproduce saturated colors. One of the most popular solutions is to use a 3×3 matrix with coefficients adjusted to obtain the required level of color saturation. However, in order to reach high color saturation levels, it is often necessary to use large coefficient values for the matrix, effectively amplifying noise levels in the output signals. Another detrimental side effect is that use of the matrix also alters the pure luminance level, which should be invariant and independent of the level of color saturation. In the above prior art saturation procedure, not only is the luminance level altered, but also noise in the luminance channel is amplified. That is a significant disadvantage, since human vision is more sensitive to noise in luminance than in chrominance.

Prior art methods for improving color saturation include both saturating primary colors before conversion to luminance and chrominance (in R, G, B color space), and amplifying chrominance signals after conversion (thus amplification in the Y, Cr/V, Cb/U color space) to increase saturation. Both of these methods have disadvantages, including not being able to suppress noise while simultaneously preserving luminance linearity.

### SUMMARY OF THE INVENTION

The present invention is a low complexity apparatus and method for color saturation performed in combination with RGB to YUV color space conversion. According to one aspect, the present invention is an image processing apparatus that is adapted to perform color conversion and variable color saturation of input primary color signals red, green and blue to produce variable chrominance signals and luminance invariance. The apparatus includes a luminance composition module dependent on non-varying luminance composition coefficients. A first chrominance composition module is dependent on the non-varying luminance composition coefficients and includes a first variable saturation coefficient that is multiplied by the difference between low pass filtered red and green primary color signals. A second chrominance composition module is also dependent on the non-varying luminance composition coefficients and includes a second variable saturation coefficient that is multiplied by the difference between low pass filtered blue and green primary color signals. The present invention is thus designed to direct input signal noise away from the luminance channel, to which the human eye is highly sensitive, and into the chrominance channels. That preserves luminance linearity when performing color saturation.

According to another aspect, the present invention is a method of image processing. The method first includes receiving input primary color signals red, green and blue. An output luminance sample is then determined using a luminance composition module that is dependent on non-varying luminance composition coefficients. Next, a first output chrominance sample is determined using a first chrominance composition module that is dependent on the non-varying luminance composition coefficients. The first chrominance composition module includes a first variable saturation coefficient multiplied by the difference between low pass filtered red and green primary color signals. A second output chrominance sample is also determined using a second chrominance composition module that is dependent on the non-varying luminance composition coefficients. The second chrominance composition module includes a second variable saturation coefficient multiplied by the difference between low pass filtered blue and green primary color signals.

### BRIEF DESCRIPTION OF THE DRAWINGS

In order that the invention may be readily understood and put into practical effect, reference will now be made to an exemplary embodiment as illustrated with reference to the accompanying drawings, wherein like reference numbers refer to like elements, in which:

FIG. 1 is a schematic diagram of a color saturation module according to an embodiment of the present invention;

FIG. 2 is a flow diagram illustrating a method of image processing according to an embodiment of the present invention; and

FIG. 3 is a graph that illustrates advantages of the present invention over prior art methods of chrominance amplification and conventional saturation in terms of noise reduction during variable color saturation.

### DETAILED DESCRIPTION OF THE INVENTION

In color image sensors it is desirable to divert, if possible, noise from a luminance channel to chrominance channels, because human vision is more sensitive to noise in luminance than in chrominance. It is also possible to reduce noise in chrominance channels, employing low pass spatial filtering (LPF), without affecting the visible sharpness of an image, if the luminance is unaffected by LPF. The present invention enables such transfer and reduction of noise, and thus enables variable saturation levels of color without increasing visible noise, using a low complexity algorithm. The invention can be used in numerous applications and can be implemented very efficiently in hardware as well as in software.

Prior art methods of color saturation include the disadvantage of not being able to suppress noise while simultaneously preserving luminance. It is mathematically proven that color saturation during conversion to luminance and chrominance produces the best noise suppression for a desired level of color saturation, keeping the luminance invariant. The positioning of the color saturation computation is derived mathematically to produce optimized noise suppression while achieving the desired color saturation level without affecting the luminance.

To saturate colors in an image without affecting the luminance, it is best performed in the Hue-Saturation-Value (HSV) color space. However, the standard equations for converting RGB color data to HSV space are as follows:

$$\begin{matrix}H = {cos}^{- 1} \{ \frac{0.5 [ ( R - G ) + ( R - B ) ]}{{[ {( R - G )}^{2} + ( R - B ) ( G - B ) ]}^{1 / 2}} \} & Eq . 1 \\ S = 1 - \frac{2}{( R + G + B )} [ min ( R , G , B ) ] & Eq . 2 \\ V = \frac{1}{3} ( R + G + B ) & Eq . 3\end{matrix}$$

As can be seen, these equations are highly complex. Further complexity is added by the computations required for returning back to RGB color space, since HSV color space is used only for analysis and not for video transmission, compression or display. Therefore, color saturation is usually performed either in RGB or YUV (or YCrCb) color space.

According to the present invention color saturation is performed during the conversion of color space from RGB to YUV. Low pass filtering (LPF) actions are incorporated only on the path of the chrominance signals, however, in the RGB space. Color saturation is achieved partly by color channel separation in the RGB space and also partly when computing the chrominance channels. No extra multipliers are incorporated on the resulting chrominance signals to increase their amplitude. The method of the present invention is thus superior to the prior art from the standpoint of noise suppression while still achieving high color saturation values.

The method of the present invention operates on each pixel of an input pixel array, considering a N×N spatial window for low pass filtering (LPF) action. LPF can be performed using simple averaging of the same channel pixel values in a neighborhood. According to one embodiment, the value of N is recommended to be larger than 1 and smaller than 4, in order to prevent excessive use of computational resources without contributing to the statistical significance of the average result.

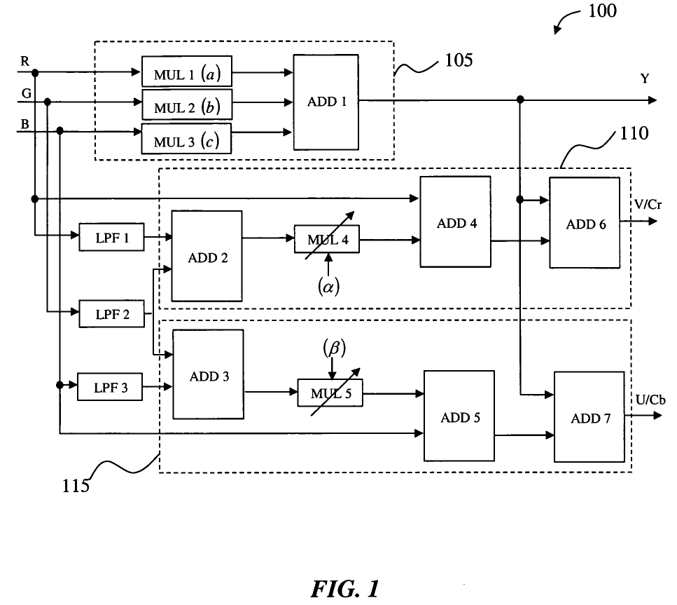

Referring to FIG. 1, there is a schematic diagram of a color saturation module 100 according to an embodiment of the present invention. The color saturation module 100 comprises a luminance composition module 105 and first and second chrominance composition modules 110, 115. In the luminance composition module 105, input primary color signals, or R, G and B values, are connected to an adder (ADD 1) via multipliers (MUL 1-MUL 3) for generating a luminance (Y) channel value. If a, b, c represent the multiplier values of MUL 1 to MUL 3, the non-varying luminance composition coefficients, it is required that a+b+c=1 and a,b,c>0. Therefore, \sqrt{a²+b²+c²}<1, hence the noise level will be suppressed in the Y channel. Those skilled in the art will recognize that multipliers MUL 1-MUL 3 can be easily replaced with shift and add operations, since the coefficients (a,b,c) are fixed and can be made hardware friendly.

MUL 4 and MUL 5 control the adaptive saturation levels in the first and second chrominance composition modules 110, 115. Therefore, the Y channel value will be unaffected at any different color saturation level and the linearity of Y is preserved. It should be noted that LPF signals are only connected to the paths of V/Cr and U/Cb chrominance outputs. Therefore, sharpness in the luminance (Y) channel will also be unaffected at different saturation levels.

The primary color channel differences are computed at adders (ADD 2, ADD 3) using the LPF signals to suppress the noise amplification. This difference is an indication of saturation of the primary colors red (R) and blue (B) compared to green (G). The multiplier MUL 4 can be used to invoke the variable saturation level on red. If the variable saturation coefficient α represents the multiplier value for MUL 4, α can be regarded as the percentage red saturation increase. The value of α is larger than 0 for saturation increase. According to one embodiment for use with CCD imagers, a recommended value for α is 0.8 for an 80% saturation increase. However, according to another embodiment of the present invention for use with CMOS imagers, α=3.5 is recommended to achieve a CCD equivalent color saturation. At the adder ADD 4 the output noise level will be larger than the input noise level (σ) but smaller than (\sqrt{α²1})σ due to LPF action. The use of LPF signals spatially distributes that noise. Higher α values correspond to larger separation of primary colors, resulting in higher saturation in the chrominance (V/Cr) signal. A similar operation is performed using multiplier MUL 5 to produce a saturated chrominance (U/Cb) signal.

The method of the present invention is thus designed, mathematically, to direct input signal noise away from the luminance channel and into the chrominance channels. However, use of LPF signals (in RGB color space) alleviates the increase in noise in chrominance channels for all saturation levels. It is also known that sharpness and noise in the luminance channel is more visible to the human eye. That is why, in most image compression schemes, the chrominance channels are sub-sampled or smoothed while the luminance channel (Y) is preserved.

Thus according to one embodiment of the present invention, the color saturation module 100 shown in FIG. 1 may be defined mathematically as follows. Assume input primary color signals (R,G, B) are one-dimensional digitized signals comprising samples
R={R₀,R₁,R₂ . . . Rₙᵣ}, Eq. 4
G={G₀,G₁,G₂ . . . . G_{ng}}, and Eq. 5
B={B₀,B₁,B₂ . . . B_{nb}}; Eq. 6
where {R₀, G₀, B₀} represent samples of interest; and {R₁ . . . Rₙᵣ}, {G₁ . . . . G_{ng}}, {B₁ . . . B_{nb}} represent neighborhood samples. Then the low pass filtered (LPF) primary color signals are given by
\overline{R}=LPF{R₀,R₁,R₂ . . . Rₙᵣ}, Eq. 7
\overline{G}=LPF{G₀,G₁,G₂ . . . G_{ng}}, and Eq. 8
\overline{B}=LPF{B₀,B₁,B₂ . . . B_{nb}}. Eq. 9
An output luminance sample (Y₀) and output chrominance samples (V₀, U₀) are then given by
Y₀=aR₀+bG₀+cB₀, Eq. 10
V₀=(1−a)R₀−bG₀−cB₀+α(\overline{R}−\overline{G}), and Eq. 11
U₀=(1−c)B₀−bG₀−aR₀+β(\overline{B}−\overline{G}); Eq. 12
where (a,b,c) represent the non-varying luminance composition coefficients, and (α, β) represent the first and second, respectively, variable saturation coefficients that are adjustable by a user.

The LPF mechanisms used to determine the low pass filtered primary color signals may include any standard or non-standard sample composition mechanism such as average filters, weighted average filters, moving average filters, box filters, and Gaussian filters. Where a simple averaging low pass filter is used, the above equations may be reduced to the following:

$$\begin{matrix}\overline{R} = LPF \{ {R}_{0} , {R}_{1} , {R}_{2} … {R}_{nr} \} = \frac{1}{nr + 1} {\sum }_{i = 0}^{nr} {R}_{i} & Eq . 13 \\ \overline{G} = LPF \{ {G}_{0} , {G}_{1} , {G}_{2} … {G}_{ng} \} = \frac{1}{ng + 1} {\sum }_{i = 0}^{ng} {G}_{i} & Eq . 14 \\ \overline{B} = LPF \{ {B}_{0} , {B}_{1} , {B}_{2} … {B}_{nb} \} = \frac{1}{nb + 1} {\sum }_{i = 0}^{nb} {B}_{i} & Eq . 15\end{matrix}$$

Substitution of these values in the general module equations form the following exact mathematical equations:

$$\begin{matrix}{Y}_{0} = {aR}_{0} + {bG}_{0} + {cB}_{0} & Eq . 16 \\ ( {V}_{0} or {Cr}_{0} ) = ( 1 - a ) {R}_{0} - {bG}_{0} - {cB}_{0} + ( \frac{α}{nr + 1} {\sum }_{i` = 1}^{nr} {R}_{i} - \frac{α}{ng + 1} {\sum }_{i = 1}^{ng} {G}_{i} ) & Eq . 17 \\ ( {U}_{0} or {Cb}_{0} ) = ( 1 - c ) {B}_{0} - {bG}_{0} - {aR}_{0} + ( \frac{α}{nb + 1} {\sum }_{i = 1}^{nb} {B}_{i} - \frac{α}{ng + 1} {\sum }_{i = 1}^{ng} {G}_{i} ) & Eq . 18\end{matrix}$$

Most image sensors produce RGB color signals (except sensors with CMY Color Filter Arrays (CFAs)), and most imaging systems produce luminance and chrominance signals for video/image transmission, compression and display. It is also known that saturated colors are preferred on video or image output (many digital video and still cameras produce saturated colors in a mode known as vivid color mode). Therefore, the present invention is positioned within a widely used image processing chain for both analog and digital image and video capture devices. The invention is thus applicable to numerous image capture systems using both CCD or CMOS image sensors, such as mobile phone cameras.

Following is a mathematical description of the present invention compared to conventional color saturation methods and chrominance amplification methods.

Present Invention:

The color saturation is performed using the following formulae:
R_{c}=R+α(\overline{R}−\overline{G}) Eq. 19
and
B_{c}=B+β×(\overline{B}−\overline{G}) Eq. 20
Assume α=β for equal separation of red and blue primary colors for mathematical simplicity. However, this is not an essential condition and the final result of the mathematical analysis is the same regardless of this separation being equal or unequal. R_{c} and B_{c} are saturated values and the low pass filtered primary color signals, \overline{R}, \overline{G} and \overline{B} values, represent the local average values for the R, G and B channels. The average values are used to suppress the noise at color saturation stage. For simplicity, it is possible to replace the average values with the pixel value, assuming a constant color area. That assumption also does not affect the noise computations in any way.

Therefore, the above equations can be simplified to,
R_{c}=(1+α)R−αG Eq. 21
B_{c}=(1+α)B−αG, since β=α. Eq. 22
For calculating resulting noise, a 4×4 Bayer window of original color signals can be considered. Such a window would contain 8 green, 4 red and 4 blue signals. Therefore,

$$\begin{matrix}noise [ \overline{G} ] = \sqrt{8 * {( \frac{1}{8} )}^{2}} σ = 0.3536 σ & Eq . 23 \\ noise [ \overline{R} ] = \sqrt{4 * {( \frac{1}{4} )}^{2}} σ = 0.5 σ & Eq . 24 \\ noise [ \overline{B} ] = \sqrt{4 * {( \frac{1}{4} )}^{2}} σ = 0.5 σ & Eq . 25\end{matrix}$$

where σ represents the input signal noise.
The noise in R_{c} and B_{c} can be calculated as follows:

$$\begin{matrix}noise [ {R}_{c} ] = \sqrt{{( σ )}^{2} + {( α * ( \sqrt{{( 0.5 σ )}^{2} + {( 0.3536 σ )}^{2}} ) )}^{2}} & Eq . 26 \\ noise [ {B}_{c} ] = \sqrt{{( σ )}^{2} + {( α * ( \sqrt{{( 0.5 σ )}^{2} + {( 0.3536 σ )}^{2}} ) )}^{2}} & Eq . 27\end{matrix}$$

For 50% saturation increase (i.e. α=0.5),
noise[R_{c}]=1.0458σ Eq. 28
noise[B_{c}]=1.0458σ. Eq. 29
If the luminance is computed using non-saturated RGB values, the approximate (hardware friendly) equation is given below:
Y=0.25R+0.625G+0.125B. Eq. 30
The chrominance values are computed using the following equations:
U=B_{c}−Y Eq. 31
V=R_{c}−Y. Eq. 32
Computing the noise in luminance (Y) directly yields,

$$noise [ Y ] = \sqrt{{( 0.25 σ )}^{2} + {( 0.625 σ )}^{2} + {( 0.125 σ )}^{2}} = 0.68465 σ . \qquad Eq . 33$$

The noise in the chrominance channels are given by,

$$\begin{matrix}noise [ V ] = \sqrt{{( σ )}^{2} + {( α * ( \sqrt{{( 0.5 σ )}^{2} + {( 0.3536 σ )}^{2}} ) )}^{2} + {( 0.68465 σ )}^{2}} & Eq . 34 \\ noise [ U ] = \sqrt{{( σ )}^{2} + {( α * ( \sqrt{{( 0.5 σ )}^{2} + {( 0.3536 σ )}^{2}} ) )}^{2} + {( 0.68465 σ )}^{2}} & Eq . 35\end{matrix}$$

Computing the noise in the chrominance channels (U, V) for α=0.5 yields,
noise[U]=\sqrt{(1.0458σ)²+(0.68465σ)²}=1.25σ Eq. 36
noise[V]=\sqrt{(1.0458σ)²+(0.68465σ)²}=1.25σ Eq. 37
Conventional Color Saturation Method:
In the conventional color saturation method, the primary colors (R,G,B) are saturated prior to RGB to YUV color space conversion. Using the assumption of a constant colored patch, U and V can be written as,
U=−0.25R−(0.625+α)G+(0.875+α)B Eq. 38
V=(0.75+α)R−(0.625+α)G−0.125B. Eq. 39
It is possible to represent the equivalent RGB to YUV color conversion matrix with color saturation as follows:

$$[ \begin{matrix}Y \\ U \\ V\end{matrix} ] = [ \begin{matrix}0.25 & 0.625 & 0.125 \\ - 0.25 & - ( 0.625 + α ) & ( 0.875 + α ) \\ ( 0.75 + α ) & - ( 0.625 + α ) & - 0.125\end{matrix} ] [ \begin{matrix}R \\ G \\ B\end{matrix} ] \qquad Eq . 40$$

The conventional method for color saturation and correction and post conversion to YUV involves the following matrix conversions:

$$\begin{matrix}Step 1 \text{:} \\ [ \begin{matrix}{R}_{c} \\ {G}_{c} \\ {B}_{c}\end{matrix} ] = [ \begin{matrix} & & \\ & CC & \\ & & \end{matrix} ] [ \begin{matrix}R \\ G \\ B\end{matrix} ] \\ where [ \begin{matrix} & & \\ & CC & \\ & & \end{matrix} ] is the color saturation / correction matrix . & Eq . 41 \\ Step 2 \text{:} \\ [ \begin{matrix}Y \\ U \\ V\end{matrix} ] = [ \begin{matrix}0.25 & 0.625 & 0.125 \\ - 0.25 & - 0.625 & 0.875 \\ 0.75 & - 0.625 & - 0.125\end{matrix} ] [ \begin{matrix}{R}_{C} \\ {G}_{C} \\ {B}_{C}\end{matrix} ] . & Eq . 42\end{matrix}$$

If the saturation levels are to be the same according to both the present invention and conventional methods of color saturation, it is possible to compute the equivalent color saturation matrix [CC] as shown below:

$$Eq . 43 \text{:} \\ [ \begin{matrix} & & \\ & CC & \\ & & \end{matrix} ] = {[ \begin{matrix}0.25 & 0.625 & 0.125 \\ - 0.25 & - 0.625 & 0.875 \\ 0.75 & - 0.625 & - 0.125\end{matrix} ]}^{- 1} [ \begin{matrix}0.25 & 0.625 & 0.125 \\ - 0.25 & - ( 0.625 + α ) & ( 0.875 + α ) \\ ( 0.75 + α ) & - ( 0.625 + α ) & - 0.125\end{matrix} ]$$

$$\begin{matrix}[ \begin{matrix} & & \\ & CC & \\ & & \end{matrix} ] = [ \begin{matrix}1.0 & 0.0 & 1.0 \\ 1.0 & - 0.2 & - 0.4 \\ 1.0 & 1.0 & 0.0\end{matrix} ] [ \begin{matrix}0.25 & 0.625 & 0.125 \\ - 0.25 & - ( 0.625 + α ) & ( 0.875 + α ) \\ ( 0.75 + α ) & - ( 0.625 + α ) & - 0.125\end{matrix} ] & Eq . 44 \\ [ \begin{matrix} & & \\ & CC & \\ & & \end{matrix} ] = [ \begin{matrix}( 1 + α ) & - α & 0 \\ - ( 0.4 α ) & ( 1 + 0.6 α ) & - ( 0.2 α ) \\ 0 & - α & ( 1 + α )\end{matrix} ] & Eq . 45\end{matrix}$$

Therefore, the noise in color saturated signals are given by,
Noise[R_{c}]={square root over (((1+α)σ)²+(ασ)²)} Eq. 46
Noise[G_{c}]={square root over ((0.4ασ)²+((1+0.6α)σ)²+(0.2ασ)²)} Eq. 47
Noise[B_{c}]={square root over (((1+α)σ)²+(ασ)²)} Eq. 48
For 50% increase in saturation (i.e. α=0.5):
Noise[R_{c}]=\sqrt{(1.5σ)²+(0.5σ)²}=1.581139σ Eq. 49
Noise[G_{c}]=\sqrt{(0.2σ)²+(1.3σ)²+(0.1σ)²}=1.319091σ. Eq. 50
Noise[B_{c}]=\sqrt{(1.5σ)²+(0.5σ)²}=1.581139σ. Eq. 51
That noise will be transferred to the final Y, U and V signals as shown below:
Noise[Y]=σ\sqrt{(0.25²×1.581139²+0.625²×1.31909²+0.125²×1.581139²)}=0.935414σ Eq. 52:
Similarly,
Noise[U]=σ\sqrt{1.581139²×0.935414²}=1.837117σ Eq. 53
Noise[V]=σ\sqrt{1.581139² ×0.935414²}=1.837117σ Eq. 54
Chrominance Amplification Method:
In the chrominance amplification method, no prior color saturation on primary R, G, B colors are performed. Chrominance is simply amplified by multiplying the U and V channel amplitudes. The luminance in this case is unaltered and is identical to the luminance (Y) level according to the present invention.
Y=0.25R+0.625G+0.125B Eq. 55
The chrominance values are computed using the following equations:
U=(1+α)×(B−Y) Eq. 56
V=(1+α)×(R−Y) Eq. 57
For 50% saturation increase, α=0.5:
computing the noise in luminance (Y) directly yields,
noise[Y]=\sqrt{(0.25σ)²+(0.625σ)²+(0.125σ)²}=0.68465σ; Eq. 58
computing the noise in Chrominance channels (U, V) yields
noise[U]=1.5×\sqrt{(σ)²+(0.68465σ)²}=1.8179σ Eq. 59
noise[V]=1.5×\sqrt{(σ)²+(0.68465σ)²}=1.8179σ. Eq. 60

Table 1 below gives a comparison of noise levels when using the method of the present invention and the conventional and chrominance amplification algorithms of the prior art, considering a 50% increase in color saturation (i.e., α=0.5):

TABLE 1
Noise Levels

| | | Chrominance | |
|---|---|---|---|
| Channel | Conventional | Amplification | Present Invention |
| Y | 0.935414 | 0.68465 | 0.68465 |
| U | 1.837117 | 1.8179 | 1.25 |
| V | 1.837117 | 1.8179 | 1.25 |

Table 2 shows the percentage decrease of noise in each channel using the saturation method of the present invention compared to the prior art conventional and chrominance amplification methods.

TABLE 2
Percentage Decrease of Noise

| | Compared to | Compared to Chrominance |
|---|---|---|
| Channel | Conventional | Amplification |
| Y | 36.66% | None |
| U | 46.97% | 45.43% |
| V | 46.97% | 45.43% |

Compared to the conventional method, the noise level in Y (luminance channel), to which human vision is most sensitive, is computed with significant noise suppression. Also, the new method of color saturation does not affect the luminance level while increasing the saturation level, which produces good gray scale linearity even in colored regions, unlike conventional algorithms. Also, at low light levels (when the signal to noise ratio (SNR) of input signals are low), colors are less important and luminance (Y) may even have to be increased (by multiplication) to increase brightness. Having less noise in Y is thus important for general noise perception, and also if some sharpening methods are used on Y. The present invention thus provides a low complexity method of spreading noise out of important channels and into other less important channels.

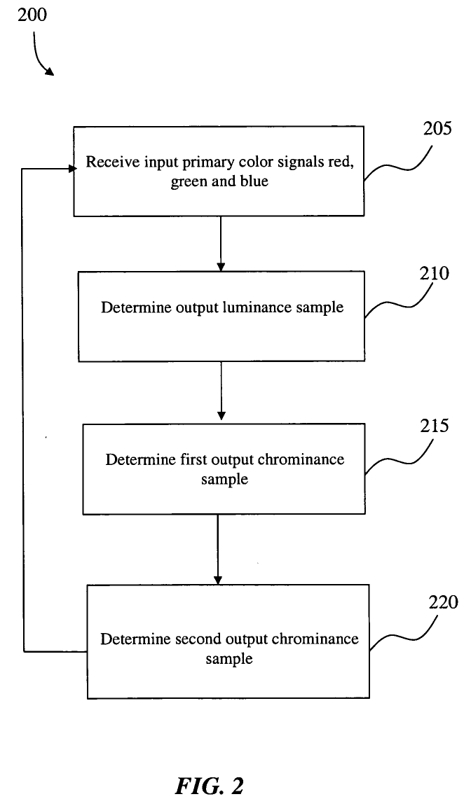

Referring to FIG. 2, there is a flow diagram illustrating a method 200 of image processing according to an embodiment of the present invention. As described above, the method 200 performs color conversion and variable color saturation of input primary color signals red, green and blue, to produce variable chrominance signals and luminance invariance. First, at step 205, input primary color signals for red, green and blue are received. Next, at step 210, the method 200 determines an output luminance sample using the luminance composition module 105 that is dependent on non-varying luminance composition coefficients (such as a,b,c). At step 215, a first output chrominance sample is determined using the first chrominance composition module 110 that is dependent on the non-varying luminance composition coefficients. The first chrominance composition module 110 includes a first variable saturation coefficient (e.g., α) multiplied by the difference between low pass filtered red and green primary color signals. At step 220, a second output chrominance sample is determined using the second chrominance composition module 115 that is dependent on the non-varying luminance composition coefficients. The second chrominance composition module 115 includes a second variable saturation coefficient (e.g., β) multiplied by the difference between low pass filtered blue and green primary color signals.

Compared to simple chrominance amplification, the present invention provides a significant noise advantage in the chrominance channels for the same level of color saturation. That noise advantage is achieved using low pass filtering (LPF) performed on the chrominance paths. However, direct application of LPF on computed chrominance values can produce color artifacts and low color contrast. Therefore, the present invention positions the LPF action in a mathematically optimized position in the processing path for low noise and high sharpness and contrast, while preserving the luminance level at all variable color saturation levels.

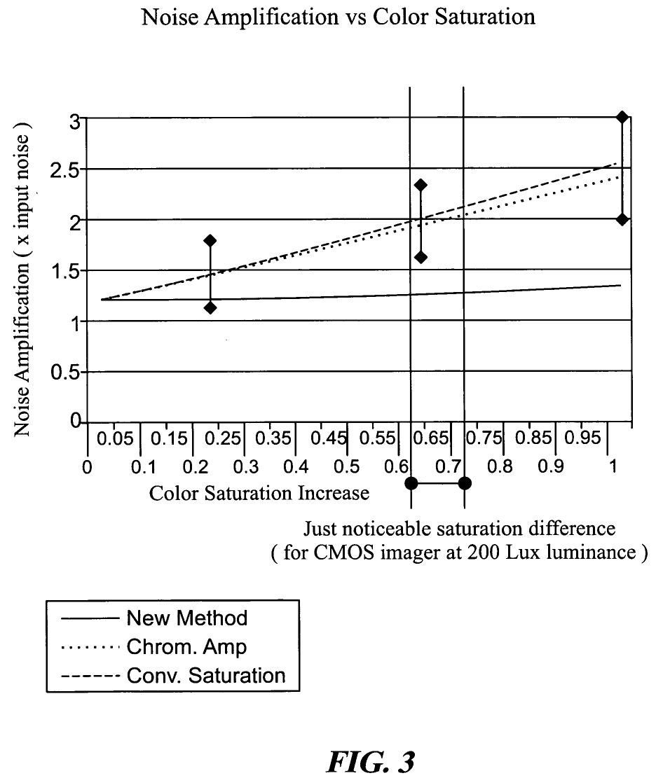

Referring to FIG. 3, there is a graph that illustrates advantages of the present invention over the prior art methods of chrominance amplification and conventional saturation in terms of noise reduction during variable color saturation. The vertical bars on the graph show ±2 dB difference in the output signal noise. Such a difference in the noise level can be just noticeable by a human observer on a video display. For a still image, the tolerance level is even smaller, approximately ±1.4 dB. Many factors affect a just noticeable difference in saturation including the type of image sensor (e.g., CMOS, CCD), the illumination type (e.g., daylight, fluorescent, tungsten, etc.) and the luminance level.

The present invention is therefore capable of achieving visibly lower noise levels for an identical visible level of saturation, especially when a saturation level increase is larger than 40%, which is true for most imagers. Since saturated (vivid) colors are demanded by almost all color displays in consumer products, and since most image capture devices (analog and digital) produce luminance and chrominance outputs for transmission as well as for image compression, the present invention is relevant to most current and future image capture and transmission products, such as stand alone digital cameras, and digital cameras included in devices such as mobile phones and personal digital assistants.

In summary, the present invention is a low complexity apparatus and method for color saturation performed in combination with RGB to YUV color space conversion. The invention provides for image quality improvements over prior art image capture systems, and the low complexity of the invention enables its integration into miniaturized image capture devices such as mobile phone cameras. Other particular advantages of the invention include reducing Y channel noise; preserving luminance linearity while performing color saturation; preserving maximum sharpness in the Y channel; moving input RGB noise from the Y channel to the U and V channels; and reducing U and V channel noise.

The above detailed description provides an exemplary embodiment only, and is not intended to limit the scope, applicability, or configuration of the present invention. Rather, the detailed description of the exemplary embodiment provides those skilled in the art with an enabling description for implementing the exemplary embodiment of the invention. It should be understood that various changes can be made in the function and arrangement of elements and steps without departing from the spirit and scope of the invention as set forth in the appended claims.

We claim:

1. An image processing apparatus adapted to perform color conversion and variable color saturation of input primary color signals red, green and blue, to produce variable chrominance signals and luminance invariance, comprising:
a luminance composition module dependent on non-varying luminance composition coefficients;
a first chrominance composition module dependent on the non-varying luminance composition coefficients and comprising a first variable saturation coefficient multiplied by the difference between low pass filtered red and green primary color signals; and
a second chrominance composition module dependent on the non-varying luminance composition coefficients comprising a second variable saturation coefficient multiplied by the difference between low pass filtered blue and green primary color signals.

2. The apparatus according to claim 1, wherein the input primary color signals (R,G, B) are one-dimensional digitized signals comprising samples
R={R₀,R₁,R₂ . . . },
G={G₀,G₁,G₂ . . . G_{ng}}, and
B={B₀,B₁,B₂ . . . B_{nb}};
wherein {R₀, G₀, B₀} represent samples of interest;
wherein {R₁ . . . Rₙᵣ}, {G₁ . . . G_{ng}}, {B₁ . . . B_{nb}} represent neighborhood samples;
wherein the low pass filtered (LPF) primary color signals are given by
\overline{R}=LPF{R₀,R₁,R₂ . . . Rₙᵣ},
\overline{G}=LPF{G₀,G₁,G₂ . . . G_{ng}}, and
\overline{B}=LPF{B₀,B₁,B₂ . . . B_{nb}};
wherein an output luminance sample (Y₀) and output chrominance samples (V₀, U₀) are given by
Y₀=aR₀+bG₀+cB₀,
V₀=(1−a)R₀−bG₀cB₀+α(\overline{R}−\overline{G}), and
U₀=(1−c)B₀−bG₀aR₀+β(\overline{B}−\overline{G});
wherein (a, b, c) represent the non-varying luminance composition coefficients; and
wherein (α, β) represent the first and second, respectively, variable saturation coefficients that are adjustable by a user.

3. The apparatus according to claim 2, wherein the low pass filtered primary color signals are determined using low pass filtering (LPF) mechanisms selected from the group consisting of average filters, weighted average filters, moving average filters, box filters, and Gaussian filters.

4. The apparatus according to claim 2, wherein the low pass filtered (LPF) primary color signals are given by
$$\overline{R} = LPF \{ {R}_{0} , {R}_{1} , {R}_{2} … {R}_{nr} \} = \frac{1}{nr + 1} {\sum }_{i = 0}^{nr} {R}_{i} , \\ \overline{G} = LPF \{ {G}_{0} , {G}_{1} , {G}_{2} … {G}_{ng} \} = \frac{1}{ng + 1} {\sum }_{i = 0}^{ng} {G}_{i} , and$$
$$\overline{B} = LPF \{ {B}_{0} , {B}_{1} , {B}_{2} … {B}_{nb} \} = \frac{1}{nb + 1} {\sum }_{i = 0}^{nb} {B}_{i} .$$

5. The apparatus according to claim 1, wherein an output luminance sample (Y₀) and output chrominance samples (V₀, U₀ or Cr₀, Cb₀) are given by
$${Y}_{0} = {aR}_{0} + {bG}_{0} + {cB}_{0} , \\ ( {V}_{0} or {Cr}_{0} ) = ( 1 - a ) {R}_{0} - {bG}_{0} - {cB}_{0} + \\ ( \frac{α}{nr + 1} {\sum }_{i = 1}^{nr} {R}_{i} - \frac{α}{ng + 1} {\sum }_{i = 1}^{ng} {G}_{i} ) , and \\ ( {U}_{0} or {Cb}_{0} ) = ( 1 - c ) {B}_{0} - {bG}_{0} - {aR}_{0} + \\ ( \frac{α}{nb + 1} {\sum }_{i = 1}^{nb} {B}_{i} - \frac{α}{ng + 1} {\sum }_{i = 1}^{ng} {G}_{i} ) .$$

6. The apparatus according to claim 1, wherein the luminance composition module and the first and second chrominance composition modules are embedded in a single processor.

7. The apparatus according to claim 1, wherein the luminance composition module and the first and second chrominance composition modules comprise analog signal adders and multipliers.

8. The apparatus according to claim 1, wherein the input primary color signals (R,G, B) are two-dimensional digitized signals and the low pass filtered (LPF) primary color signals are generated using image windows of arbitrary width (w) and height (h) consisting of a plurality of R,G, B samples.

9. A method of image processing comprising the steps of:
receiving input primary color signals red, green and blue;
determining an output luminance sample using a luminance composition module dependent on non-varying luminance composition coefficients;
determining a first output chrominance sample using a first chrominance composition module dependent on the non-varying luminance composition coefficients and comprising a first variable saturation coefficient multiplied by the difference between low pass filtered red and green primary color signals; and
determining a second output chrominance sample using a second chrominance composition module dependent on the non-varying luminance composition coefficients comprising a second variable saturation coefficient multiplied by the difference between low pass filtered blue and green primary color signals.

10. The method according to claim 9, wherein the input primary color signals (R,G, B) are one-dimensional digitized signals comprising samples
R={R₀,R₁,R₂ . . . Rₙᵣ},
G={G₀,G₁,G₂ . . . . G_{ng}}, and
B={B₀,B₁,B₂ . . . B_{nb}};
wherein {R₀, G₀, B₀} represent samples of interest;
wherein {R₁ . . . Rₙᵣ}, {G₁ . . . G_{ng}}, {B₁ . . . B_{nb}} represent neighborhood samples;
wherein the low pass filtered (LPF) primary color signals are given by
\overline{R}=LPF{R₀,R₁,R₂ . . . . Rₙᵣ},
\overline{G}=LPF{G₀,G₁,G₂ . . . G_{ng}}, and
\overline{B}=LPF{B₀,B₁,B₂ . . . B_{nb}};
wherein an output luminance sample (Y₀) and output chrominance samples (V₀, U₀) are given by
Y₀=aR₀+bG₀+cB₀,
V₀=(1−a)R₀−bG₀−cB₀+α(\overline{R}−\overline{G}), and
U₀=(1−c)B₀−bG₀−aR₀+β(\overline{B}−\overline{G});
wherein (a, b, c) represent the non-varying luminance composition coefficients; and
wherein (α, β) represent the first and second, respectively, variable saturation coefficients that are adjustable by a user.

11. The method according to claim 10, wherein the low pass filtered primary color signals are determined using low pass filtering (LPF) mechanisms selected from the group consisting of average filters, weighted average filters, moving average filters, box filters, and Gaussian filters.

12. The method according to claim 10, wherein the low pass filtered (LPF) primary color signals are given by
$$\overline{R} = LPF \{ {R}_{0} , {R}_{1} , {R}_{2} … {R}_{nr} \} = \frac{1}{nr + 1} {\sum }_{i = 0}^{nr} {R}_{i} , \\ \overline{G} = LPF \{ {G}_{0} , {G}_{1} , {G}_{2} … {G}_{ng} \} = \frac{1}{ng + 1} {\sum }_{i = 0}^{ng} {G}_{i} , and$$
$$\overline{B} = LPF \{ {B}_{0} , {B}_{1} , {B}_{2} … {B}_{nb} \} = \frac{1}{nb + 1} {\sum }_{i = 0}^{nb} {B}_{i} .$$

13. The method according to claim 9, wherein the output luminance sample (Y₀) and output chrominance samples (V₀, U₀ or Cr₀, Cb₀) are given by
$${Y}_{0} = {aR}_{0} + {bG}_{0} + {cB}_{0} , \\ ( {V}_{0} or {Cr}_{0} ) = ( 1 - a ) {R}_{0} - {bG}_{0} - {cB}_{0} + \\ ( \frac{α}{nr + 1} {\sum }_{i = 1}^{nr} {R}_{i} - \frac{α}{ng + 1} {\sum }_{i = 1}^{ng} {G}_{i} ) , and \\ ( {U}_{0} or {Cb}_{0} ) = ( 1 - c ) {B}_{0} - {bG}_{0} - {aR}_{0} + \\ ( \frac{α}{nb + 1} {\sum }_{i = 1}^{nb} {B}_{i} - \frac{α}{ng + 1} {\sum }_{i = 1}^{ng} {G}_{i} ) .$$

14. The method according to claim 9, wherein the luminance composition module and the first and second chrominance composition modules are embedded in a single processor.

15. The method according to claim 9, wherein the luminance composition module and the first and second chrominance composition modules comprise analog signal adders and multipliers.

16. The method according to claim 9, wherein the input primary color signals (R,G, B) are two-dimensional digitized signals and the low pass filtered (LPF) primary color signals are generated using image windows of arbitrary width (w) and height (h) consisting of a plurality of R,G, B samples.

17. An apparatus for image processing comprising:
means for receiving input primary color signals red, green and blue;
means for determining an output luminance sample using a luminance composition module dependent on non-varying luminance composition coefficients;
means for determining a first output chrominance sample using a first chrominance composition module dependent on the non-varying luminance composition coefficients and comprising a first variable saturation coefficient multiplied by the difference between low pass filtered red and green primary color signals; and
means for determining a second output chrominance sample using a second chrominance composition module dependent on the non-varying luminance composition coefficients comprising a second variable saturation coefficient multiplied by the difference between low pass filtered blue and green primary color signals.
